(19) United States
(12) Patent Application Publication
(10) Pub. No.: US 2008/0219783 A1
(43) Pub. Date: Sep. 11, 2008

(54) Cutting Segment of Cutting Tool and Cutting Tool

(75) Inventors: Soo-Kwang Kim, Photofino, CA (US); Joon Ho Chang, Kyungki-do (KR); Hee-Dong Park, Kyungki-do (KR); Jong-Ho Kim, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignees: EHWA DIAMOND INDUSTRIAL CO., LTD., Osan (KR); GENERAL TOOL, INC., Irvine, CA (US)

(21) Appl. No.: 11/722,935

(22) PCT Filed: Dec. 28, 2005
(86) PCT No.: PCT/KR05/04603

§ 371 Date: Jan. 9, 2008

(30) Foreign Application Priority Data
Dec. 30, 2004 (KR) 10-2004-0116115
Mar. 30, 2005 (KR) 10-2005-0026751

(51) Int. Cl. B26D 1/00; B23D 51/10

(52) U.S. Cl. 407/114; 83/699.21

(57) ABSTRACT

A cutting segment of a cutting tool for cutting or drilling a brittle work piece such as stone, bricks, concrete and asphalt, and a cutting tool. The cutting segment includes a cutting surface for cutting a work piece and a number of abrasive particles arranged in a plurality of rows. Each of the abrasive rows includes high-concentration parts and low-concentration parts. The high-concentration parts are grouped together to form a high-concentration area on the cutting surface and the low-concentration parts are grouped together to form a low-concentration area on the cutting surface. The cutting segment and the cutting tool are capable of improving cutting rate and useful life.

### TECHNICAL FIELD

The present invention relates to a cutting segment of a cutting tool for cutting or drilling a brittle work piece such as stone, bricks, concrete and asphalt, and a cutting tool having the cutting segment. More particularly, the present invention relates to a cutting segment capable of improving cutting efficiency on abrasive particles by adequately arranging the same, and a cutting tool having the cutting segment.

### BACKGROUND ART

To cut or drill a brittle work piece such as stone, bricks, concrete and asphalt, an abrasive with higher hardness than the work piece is required.

The abrasives include artificial diamond particles, natural diamond particles, boron nitrite particles and super hard particles, of which the artificial diamond particles are most widely used.

An artificial diamond (hereinafter referred to as “diamond”) was invented in the 1950s. The diamond, which is known to have the highest hardness out of materials in the earth, has been accordingly used for cutting and grinding tools due to such properties.

Especially, the diamond has been broadly used in a stone processing field where stone such as granite and marble is cut and ground, and in a construction field where a concrete structure is cut and ground.

An explanation will be given hereunder based on cutting segments and cutting tools that utilize diamond particles as an abrasive.

Typically, a diamond tool comprises segments having diamond particles dispersed thereon and a metal core having the segments fixed thereto.

FIG. 1 illustrates an example of a segment type diamond tool.

As shown in FIG. 1, the segment type diamond tool includes a plurality of segments 11, 12 fixed to a disk-shaped metal core 2, each segment 11, 12 having the diamond particles 5 randomly dispersed thereon.

The segments are fabricated via powder metallurgy in which the segments are mixed with metal powder acting as a binder, molded and then sintered.

When the diamond particles are mixed with metal powder, the diamond particles are not evenly dispersed among metal powder but randomly dispersed in the segments.

For the cutting tool having the segments thereon, a relationship between cutting rate and useful life is contradictory. That is, if metal powder with low abrasion resistance is used to enhance cutting rate, useful life diminishes due to a weak force to retain diamond particles. In contrast, if metal powder with high abrasion resistance is used to increase useful life, diamond particles blunted during cutting are not easily released, deteriorating cutting rate in some cases.

Also, in mixing the diamond particles with metal powder acting as a binder, due to particle size and weight difference, the diamond particles are not evenly dispersed among metal powder. Thus, as shown in FIG. 1, diamond particles may be dispersed in different concentrations according to cutting surfaces: a cutting surface 3 may have too many diamond particles while a cutting surface 4 may have too few diamond particles.

When the diamond particles are dispersed in different concentrations according to the cutting surfaces as just described, both cutting rate and useful life of the cutting tool diminish. That is, in cutting, efficiency of the diamond particles declines.

Numerous attempts have been made to solve the problems, as demonstrated by U.S. Pat. No. 5,518,443.

U.S. Pat. No. 5,518,443 discloses a technology capable of improving cutting rate and useful life by randomly dispersing diamond particles on the cutting segments and successively positioning a high-concentration region and a low-concentration region in a cutting direction.

As in U.S. Pat. No. 5,518,443, when the high and low concentration regions of the diamond particles are positioned successively, in the high-concentration region, many diamond particles are exposed to the cutting surface. Accordingly, load against each diamond particle is lowered to delay wear of the diamond particles and increase useful life. In the region with no or few diamond particles, the diamond particles wear out easily so that cutting rate is boosted by fast abrasion of metal powder.

However, with respect to aforesaid U.S. Pat. No. 5,518,443, the diamond particles are randomly dispersed and are not spaced properly in the high-concentration region, leading to uniform concentration. Therefore there is a limit in improving cutting rate and useful life.

To solve a problem of segregation of the diamond particles, a patterning technology of diamond particles was suggested, as shown in FIG. 2.

FIG. 2 illustrates an example of a segment type diamond tool 20 patterned with the diamond particles.

As shown in FIG. 2, the diamond particles are patterned or regularly dispersed in each segment 21, 22.

If a work piece is cut via the segments, the diamond particles are evenly dispersed and uniformly spaced on the cutting surface, leading to uniform popularity. Accordingly, all diamond particles are involved in a cutting process continually so that efficiency of the cutting process increases.

However if the above-identified patterning technology is applied to the cutting segments with low-concentration of diamond particles (the number of the diamond particles per unit volume of the segment), there is a limit in improving cutting rate and useful life.

U.S. Pat. No. 6,110,031 teaches a technology of enhancing cutting rate and useful life by forming outer layers with high abrasion resistance on both sides and inner layers between the outer layers. The inner layers are arranged to have a high abrasion resistance part and a relatively low abrasion resistance part regularly dispersed in a cutting direction and in a direction perpendicular to the cutting direction.

But in U.S. Pat. No. 6,110,031, a high-concentration region and a low-concentration region in the inner layers are evenly dispersed across the segments in a cutting direction or in a direction perpendicular to the cutting direction. As a result, in the low-concentration region, useful life cannot be improved, whereas in the high-concentration region, the protrusion height of the diamond particles cannot be maximized due to an adjacent low-abrasion resistance area. Thus an effect of better cutting rate is insignificant.

### DISCLOSURE OF INVENTION

### Technical Problem

The present invention has been made to solve the foregoing problems of the prior art and it is therefore an object of the present invention to provide a cutting segment capable of improving cutting rate and useful life by arranging abrasive particles adequately and increasing cutting efficiency thereof, and a cutting tool having the same.

### Technical Solution

The present invention will be explained hereunder.

According to an aspect of the invention for realizing the object, there is provided a cutting segment of a cutting tool for cutting a work piece on a cutting surface, the cutting segment comprising a number of abrasive particles arranged in a plurality of rows extended along a cutting direction, the abrasive rows being placed side by side with one another across the cutting direction and stacked vertically from the cutting surface, wherein each of the abrasive rows includes high-concentration parts and low-concentration parts along the cutting direction on the cutting surface, the high-concentration parts showing a concentration higher than an average concentration of the each abrasive row, and the low-concentration parts showing a concentration lower than the average concentration, and wherein the high-concentration parts are grouped together to form a high-concentration area on the cutting surface and low-concentration parts are grouped together to form a low-concentration area on the cutting surface, and the high-concentration area and the low-concentration area are extended to both sides of the segment, respectively, wherein the low-concentration areas have a polygonal contour on the cutting surface, and wherein the high-concentration area alternates with the low-concentration area along the cutting direction.

According to another aspect of the invention for realizing the object, there is provided a cutting tool having a cutting segment thereon.

A cutting segment of a cutting tool for cutting a work piece on a cutting surface, the cutting segment comprising a number of abrasive particles arranged in a plurality of rows extended along a cutting direction, the abrasive rows being placed side by side with one another across the cutting direction and stacked vertically from the cutting surface, wherein the abrasive rows include outer abrasive rows placed in both sides of the segment and a plurality of inner abrasive rows placed between the outer rows, wherein at least one of the outer rows has abrasive particles arranged with uniform concentration, wherein each of the inner rows includes high-concentration parts and low-concentration parts along the cutting direction on the cutting surface, the high-concentration parts showing a concentration higher than an average concentration of the each abrasive row, and the low-concentration parts showing a concentration lower than the average concentration, wherein the high-concentration parts are grouped together to form a high-concentration area on the cutting surface and low-concentration parts are grouped together to form a low-concentration area on the cutting surface, wherein the low-concentration area has a polygonal contour on a cutting surface, and wherein the high-concentration area alternates with the low-concentration area along the cutting direction.

According to still another aspect of the invention for realizing the object, there is provided a cutting tool having a cutting segment thereon.

The present invention is applied to a cutting segment of a cutting tool for cutting or drilling a brittle work piece such as stone, bricks, concrete and asphalt.

The cutting segment of the cutting tool comprises abrasive particles carrying out cutting in cutting a work piece and a metal binder fixing the abrasive particles.

According to still a further aspect of the invention for realizing the object, there is provided an arrangement of abrasive particles.

For example, with respect to the segments of the invention, the cutting segment comprises a number of abrasive particles arranged in a plurality of rows extended along a cutting direction, the abrasive rows being placed side by side with one another across the cutting direction and stacked vertically from the cutting surface.

A gap between one of outer rows placed in both sides of the segment and an adjacent inner abrasive row is 2.0 times of or less than the average diameter of the abrasive particles, and a gap between inner rows placed between the outer rows is 4.0 times of or less than the average diameter of the abrasive particles, and more preferably, 1.5 to 2.5 times the average diameter of the abrasive particles.

The abrasive rows are stacked vertically from the cutting surface.

Preferably, the abrasive rows are successively protruded from the cutting surface with a predetermined pattern in cutting a work piece.

The abrasive rows include high-concentration parts and low-concentration parts along the cutting direction from the cutting surface, the high-concentration parts showing a concentration higher than an average concentration of the each row whereas the low-concentration parts showing a concentration lower than the average concentration.

The low-concentration part may have no abrasive particles.

The high-concentration parts are grouped together to form a high-concentration area on the cutting surface and low-concentration parts are grouped together to form a low-concentration area.

If the low-concentration parts do not have any abrasive particles as just described, the low-concentration area may not have any abrasive particles either.

The low-concentration areas have a contour consisting of lines that define a polygon on the cutting surface.

Preferably, the ratio of the mean length of the high-concentration area to the mean length of the low-concentration area is 0.3 to 2.0.

The high-concentration area and low-concentration area are extended to both sides of the segment.

The high-concentration area alternates with the low-concentration area along the cutting direction.

To give another example regarding the segments of the invention, the cutting segment comprises a number of abrasive particles arranged in a plurality of rows extended along a cutting direction. The abrasive rows are placed side by side with one another across the cutting direction and stacked vertically from the cutting surface.

Preferably, the abrasive rows are successively protruded from the cutting surface with a predetermined pattern in cutting a work piece.

Each of the rows includes outer rows placed in both sides of the segment and a plurality of inner rows placed between the outer rows.

Preferably, a gap between one of outer rows placed in both sides of the segment and an adjacent inner row is 2.0 times of or less than the average diameter of the abrasive particles. Also, preferably, a gap between inner rows placed between the outer rows is 4.0 times of or less than the average diameter of the abrasive particles and more preferably, 1.3 to 2.5 times.

At least one of outer rows has abrasive particles arranged with uniform concentration.

That is, out of outer rows, one has abrasive particles arranged with uniform concentration and the other has abrasives arranged in the same way as inner rows, or all rows may be arranged with uniform concentration.

Each of the inner rows includes high-concentration parts and low-concentration parts in the cutting direction from the cutting surface, the high-concentration parts showing a concentration higher than an average concentration of the each row whereas the low-concentration parts showing a concentration lower than the average concentration.

The low-concentration parts may have no abrasive particles.

The low-concentration area has a contour consisting of lines that define a polygon on the cutting face.

The ratio of the mean length of the high-concentration area to the mean length of the low-concentration area is 0.3 to 2.0.

The inner rows are arranged in such a way that the high-concentration parts are grouped together to form a high-concentration area on the cutting surface while the low-concentration parts are grouped together to form a low-concentration area on the cutting surface.

If the low-concentration parts do not have any abrasive particles as just described, the low-concentration area may not have any abrasive particles either.

Further, preferably, the inner rows are arranged in such a manner that an equal number of abrasive particles are protruded with uniform concentration at uniform spaces in a cutting direction.

According to the present invention, the inner rows adjacent to the outer rows may have abrasive particles arranged with uniform concentration, and the number of inner rows allowing arrangement of abrasive particles with uniform concentration should be less than ½ of the total inner rows.

The high-concentration alternates with the low-concentration area along the cutting direction.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is an example of a diamond tool having diamond particles randomly dispersed on a cutting surface of cutting segments;

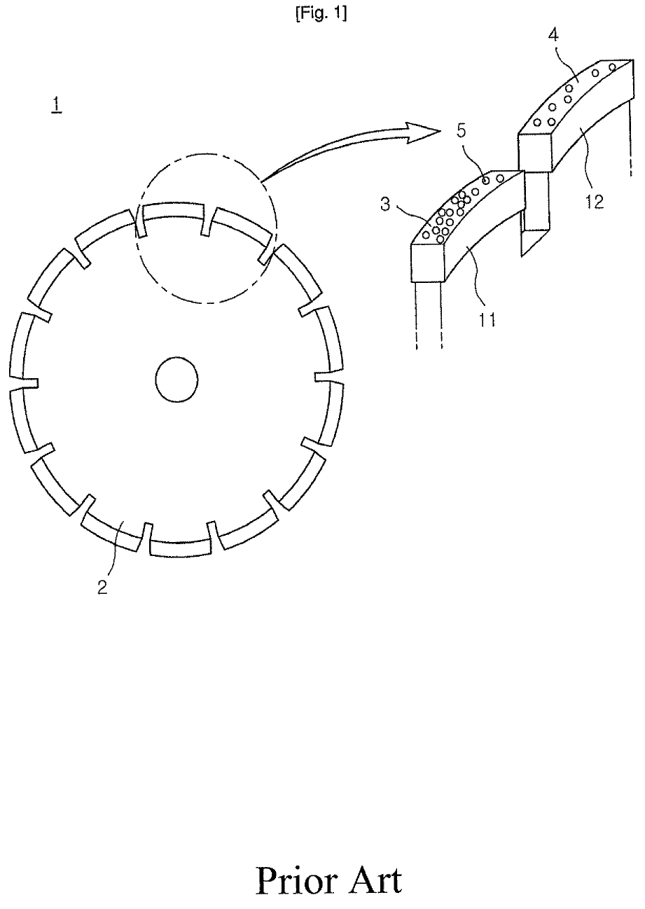

FIG. 2 is an example of the diamond tool having diamond particles regularly dispersed on a cutting surface of cutting segments;

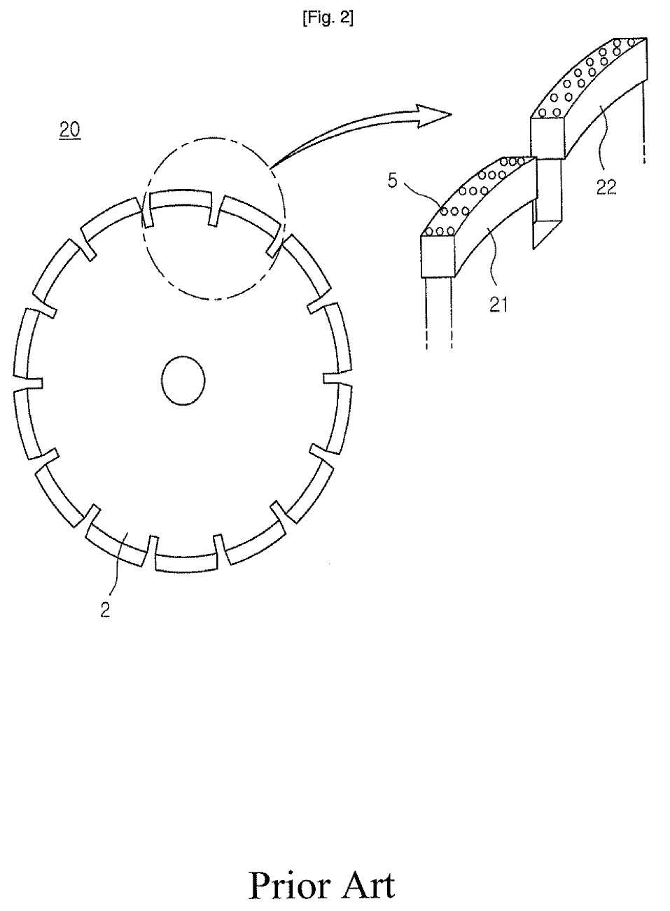

FIG. 3 is a schematic view illustrating a cutting surface of a cutting segment according to the invention, in which (a) shows a low-concentration area having a contour with two sides perpendicular to a cutting direction, and (b) shows a low-concentration area having a contour with two sides slanted from the cutting direction;

FIG. 4 is a schematic view showing arrangement of abrasive particles protruded from the cutting surface seen from the segment side in cutting, in which (a) shows arrangement by a conventional cutting segment, and (b) shows arrangement by a cutting segment of the invention;

FIG. 5 is a view showing arrangement of abrasive particles in which the abrasive rows are stacked vertically from the cutting surface according to the invention;

FIG. 6 is a schematic view showing another example of the cutting segment according to the invention, in which (a) shows abrasive particles vertically stacked from the cutting surface, (b) shows arrangement of abrasive particles dispersed on an upper face, and (c) shows arrangement of the abrasive particles dispersed on a lower face;

FIG. 7 is a schematic view showing still another example of the cutting segment according to the invention, in which (a) shows arrangement of abrasive particles of the cutting segment, and (b) shows arrangement of abrasive particles on the cutting surface;

FIG. 8 is a sectional view of the cutting segment taken along the line A-A in FIG. 3.

FIG. 9 is a configuration view of cutting segments according to the invention;

FIG. 10 is a configuration view of cutting segments according to the invention.

### MODE FOR THE INVENTION

Preferred embodiments of the present invention will now be described in detail with reference to the accompanying drawings.

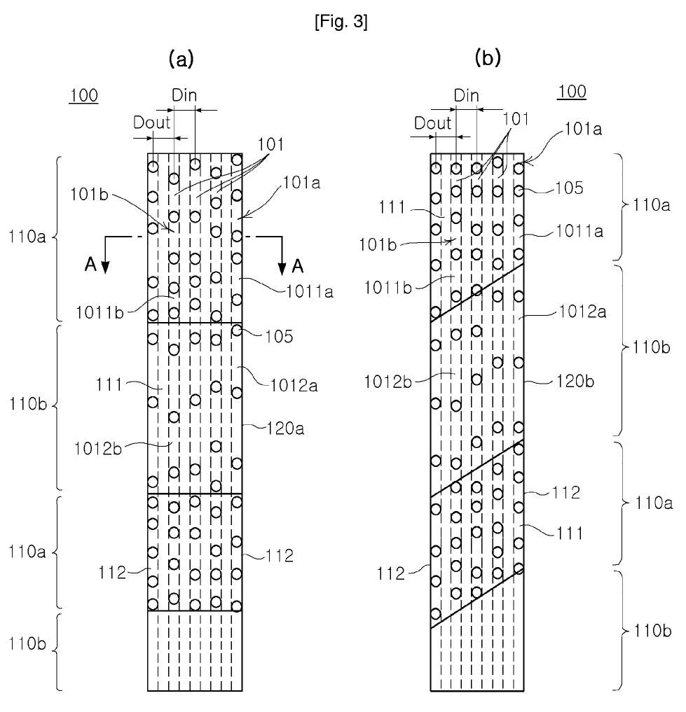

FIG. 3 shows an example of a cutting segment of the invention.

As shown in FIG. 3, the cutting segment 100 of the invention includes rows of abrasive particles 101 in which the abrasive particles 105 are arranged in a cutting direction. The cutting segment 100 according to the invention includes a number of abrasive particles arranged in a plurality of rows extended along a cutting direction.

The abrasive rows 101 are placed side by side with one another across the cutting direction and stacked vertically from the cutting direction.

Preferably, the number of the abrasive rows 101 is at least 4.

In cutting, a high-concentration area 110a sustains a big cutting load. Thus out of the abrasive rows 101, if a gap Dout between one of outer rows 101a positioned in the side and an adjacent inner row 101b is too large, outer abrasive rows fall off toward the side of the cutting segment during cutting, rendering it impossible to continue with cutting. As a result, preferably, a gap Dout between one of outer rows 101a and an adjacent inner rows is 2.0 times of or less than the average diameter of the abrasive particles.

In contrast, if a gap Din between inner rows 101b placed between the outer rows 101a is too large, a part of the segment with no abrasive particles among the abrasive rows is deeply dented so that the abrasive particles easily fall off, possibly deteriorating useful life of the cutting tool. Therefore, a gap Din between the inner rows 101b positioned between the outer rows 101a is preferably 4.0 times of or less than the average diameter of the abrasive particles, or more preferably 1.3 to 2.5 times the average diameter of the abrasive particles.

The abrasive rows are stacked vertically from the cutting surface 111.

The abrasive rows 101 include high concentration parts 1011a, 1011b and low concentration parts 1012a, 1012b along the cutting direction from the cutting surface 111.

The high concentration parts show a concentration higher than an average concentration of the each abrasive row, whereas the low-concentration parts show a concentration lower than the average concentration.

The low-concentration parts 1012a, 1012b may not have abrasive particles.

The abrasive rows 101 are arranged in such a manner that high-concentration parts 1011a, 1011b are grouped together to form a high-concentration area 110a on the cutting surface and low-concentration parts 1012a, 1012b are grouped together to form a low-concentration area 110b.

As just described, if the low-concentration parts 1012a, 1012b do not have any abrasive particles, the low-concentration area 110b may not have any abrasive particles either.

The high-concentration area 110a and low-concentration area 110b are extended to both sides 112 of the segment, respectively.

The high-concentration area 110a alternates with the low-concentration area 110b along the cutting direction.

As shown in FIG. 3a, the low-concentration area 110b has a polygonal shape, particularly a rectangular contour 120a on the cutting surface, and as shown in FIG. 3b, the low-concentration area 110b has a polygonal shape, particularly a parallelogrammic contour 120b.

Preferably, the ratio L/A of length L of the high-concentration area 110a to length A of the low-concentration area 110b is 0.3 to 2.0.

The high-concentration area 110a alternates with the low-concentration area 110b along the cutting direction.

There should be at least one high-concentration area 110a and one low-concentration area 110b, respectively.

According to the invention, the high-concentration area 110a and low-concentration area 110b on the cutting surface of the cutting segment allow cutting under a lower load. Consequently the cutting tool suffers from lower impact, leading to less vibration and noise during cutting. Especially, the present invention enhances cutting rate if the high-concentration area 110a and the low-concentration area 110b on the cutting surface of the segment have proper lengths and numbers, which will be explained hereunder.

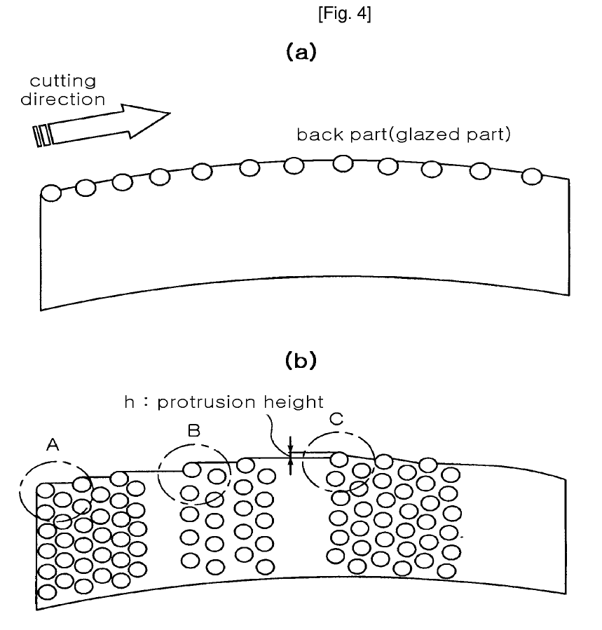

FIG. 4 shows protrusion of the abrasive particles seen from the segment side in cutting a work piece via the segment having abrasive particles regularly arranged thereon. FIG. 4(a) shows the segment marking no change in the concentration area while FIG. 4(b) shows the segment marking a change in the concentration area.

As shown in FIG. 4(a), for the segment having the diamond particles regularly arranged without any change in the concentration area, all abrasive particles are protruded with almost equal heights.

In this case, protruded abrasive particles located in a rear part of the segment in a cutting direction are buried by a tail of preceding abrasive particles, sustaining less cutting load. As a result, a sharp edge of abrasive particles is glazed, deteriorating cutting rate.

Meanwhile, as shown in FIG. 4(b), for the segment comprising the high- and low-concentration areas alternating with each other according to the invention, abrasive particles A, B, C positioned in the front of the concentration area indicate a substantial height h of protrusion thereof.

This is because relatively severe abrasion in an area with low concentration or no diamond particles leads to a high protrusion of abrasive particles in the front of a high concentration area.

Also, abrasive particles positioned in the back of a high concentration area in a cutting direction are less buried by a tail of the abrasive particles positioned in the front, thereby improving cutting rate of each abrasive particle.

That is, cutting rate is boosted in proportion to the numbers of segments in the cutting tool of the equal diameter. The present invention enhances cutting rate by accomplishing an effect as if a segment has a plurality of sub-segments.

Further, with respect to polygonal contours of the low-concentration area 110b, the contour may have at least one side slanted in a direction perpendicular to the cutting direction. This reduces impact resulting from possible severe intermission that may be caused by the high-concentration area 110a and the low-concentration area 110b alternating with each other.

Also, an explanation will be given hereunder regarding effects of the high- and low-concentration areas design on the cutting rate.

Typically, it is assumed that abrasive particles are large-sized when a hard work piece is cut with cutting speed accelerated via high-powered machine. In this case, cutting rate and useful life can be enhanced by lowering the ratio of the high-concentration area and increasing the number of the high-concentration areas.

Moreover, preferably, the number of the abrasive rows stacked in the segment should be increased so as to narrow a gap Dout between the outer rows and the inner rows, and a gap Din between the inner rows so that a groove should not be too deep.

Thus, abrasive particles and average concentration of the cutting segment should be decided in accordance with a working condition, a machine and a work piece, and then the number of abrasive rows, the number and length of the high- and low-concentration areas and local concentration therein should be decided.

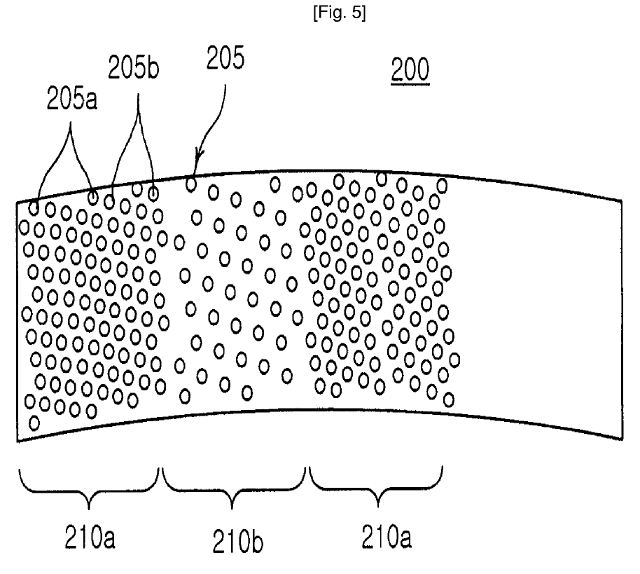

FIG. 5 shows an example in which abrasive particles of the segment are stacked vertically from the cutting surface.

As shown in FIG. 5, in the cutting segment 200 of the invention, a number of abrasive particles arranged in a plurality of rows extended along a cutting direction and the abrasive rows are stacked vertically from the cutting face.

Preferably, the abrasive rows are stacked in such a manner that in cutting a work piece, new abrasive particles 205b can be protruded among initially protruded abrasive particles 205a.

In FIG. 5, numeral 210a designates the high-concentration area, while numeral 210b designates the low-concentration area.

As in FIG. 5, the abrasive rows are stacked vertically from the cutting surface so that the abrasive particles are successively protruded at uniform intervals and with a predetermined pattern in cutting a work piece.

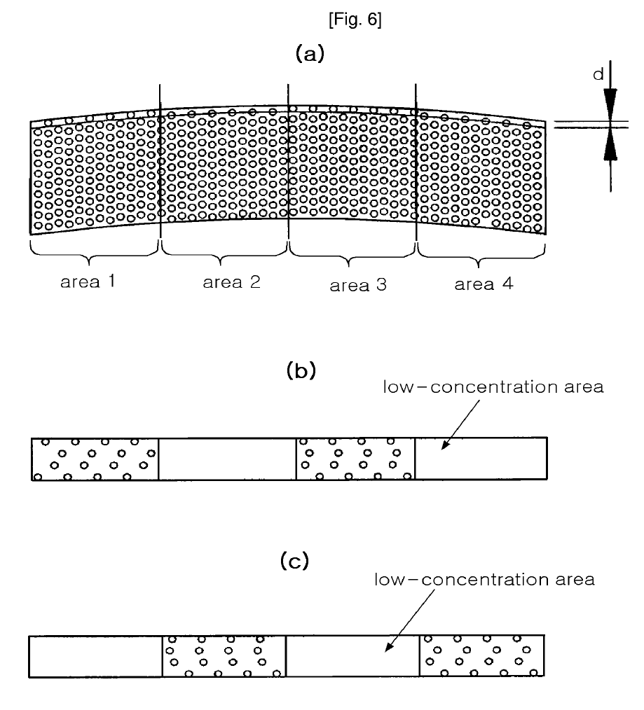

FIG. 6 shows another example of the cutting segment according to the invention.

In the invention, as shown in FIG. 6(a), the abrasive rows are stacked in such a manner that a low-concentration part of a lower abrasive row is placed corresponding to a high-concentration part of an overlying abrasive row in a direction perpendicular to the cutting surface.

In case of stacking as just described, a gap d between an overlying abrasive row and a lower abrasive row should be ½ to ⅔ of the abrasive particle size.

In case of stacking as just described, if abrasive particles on an upper cutting surface have a first area and a third area protruded in a direction perpendicular to a cutting surface as in FIG. 6(b), abrasive particles on a lower cutting surface will have a second area and a fourth area protruded as in FIG. 6(c).

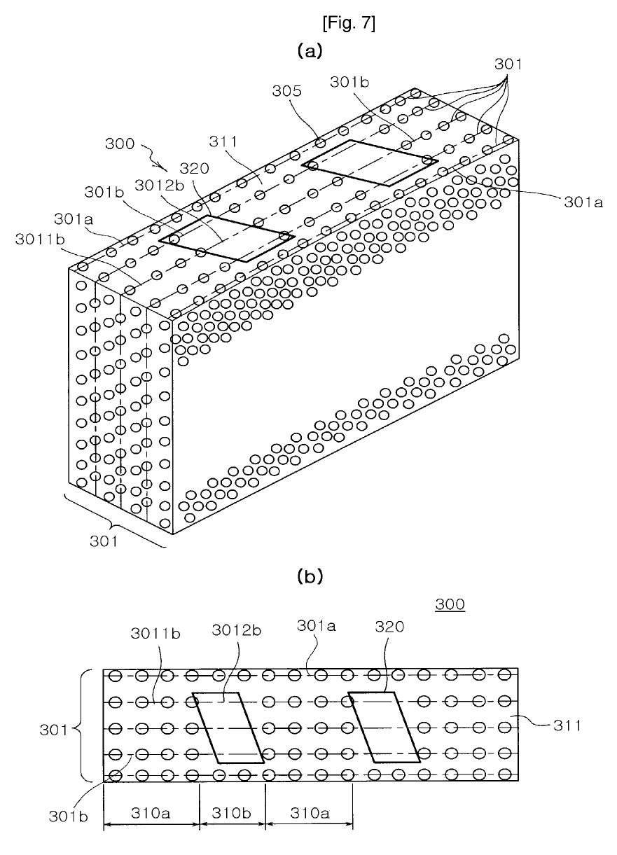

FIG. 7(a) and (b) shows still a further example of the segment according to the invention.

As shown in FIG. 7(a) and (b), abrasive particles 305 on a cutting segment 300 are arranged in rows. On a cutting surface 311a plurality of abrasive rows are arranged in a direction perpendicular to a cutting direction.

The abrasive particle rows 301 are stacked vertically from the cutting surface 311.

The abrasive rows 301 on a certain face include outer rows 301a placed in both sides of the segment and a plurality of inner rows 301b placed between the outer rows 301a.

Preferably, a gap between one of outer rows 301a and an adjacent inner row 301b is 2.0 times of or less than the average diameter of the abrasive particles. A gap between inner rows 301b is preferably 4.0 times of or less than the average diameter of the abrasive particles, and more preferably 1.3 to 2.5 times the average diameter of the abrasive particles.

At least one of the outer rows 301a has abrasive particles arranged with uniform concentration.

That is, one of outer rows 301a may have abrasive particles arranged with uniform concentration and the other one may have abrasive particles arranged in the same way as the inner rows 301b. Alternatively, both of the outer rows 301a may be arranged with uniform concentration.

The inner rows 301b include high concentration parts 3011b and low concentration parts 3012b in a cutting direction on a cutting surface 311, in which the high-concentration parts 3011b show concentration higher than an average concentration of the each row and the low-concentration parts show a concentration lower than the average concentration.

The inner rows 301b are arranged in such a manner that high concentration parts 3011b are grouped together to form a high concentration area 310a on the cutting surface 311 and low concentration parts 3012b are grouped together to form a low concentration area 3101b on the cutting surface 311.

The low-concentration area 310b has a polygonal shape, particularly, a rectangular contour 320.

The high-concentration parts 3011b of the each inner row 310b are grouped together to form the high-concentration area 310a. Preferably, the ratio L/A of length L of the high-concentration area 310a to length A of the low-concentration area 310b is 0.3 to 2.0.

The low concentration parts 3012b may have no abrasive particles as shown in FIG. 7.

If the low concentration parts 3012b of the inner rows 301b do not have any abrasive particles, the low concentration area 310b may not have any abrasive particles either.

Preferably, the inner rows 301b are arranged in such a manner that the abrasive particles can be protruded in a cutting direction at uniform intervals and with uniform concentration.

The high concentration area 310a alternates with the low concentration area 310b in a cutting direction.

Abrasive particles arranged in the high concentration area 310a have predetermined patterns.

Abrasives used in the invention are not specifically limited but preferably diamond particles are used.

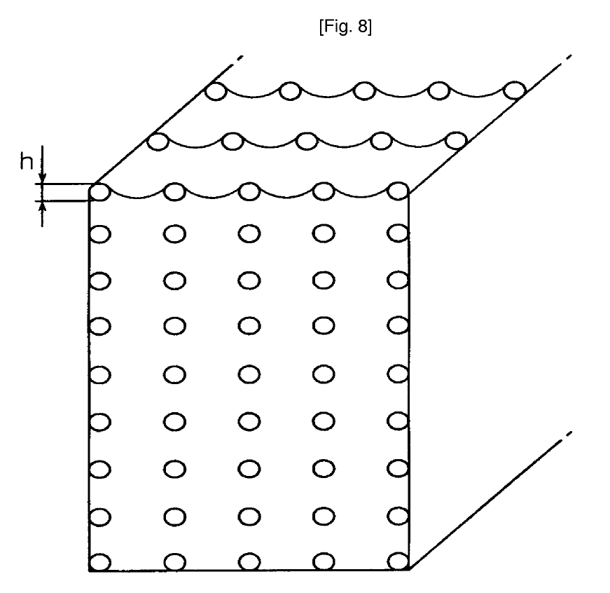

In cutting a work piece according to the invention, as shown in FIG. 8, parts with no abrasive particles among the abrasive rows suffer abrasion with proper depths during cutting process, with grooves leading from the front of the segment to the end in a cutting direction. This allows debris to be easily discharged along the deep grooves and increases protrusion height h of the abrasive rows placed between the grooves so as to cut a work piece more deeply, thereby improving cutting rate.

Moreover, for the cutting segment of the invention, the abrasive particles protruded from the cutting surface are assembled in a certain area in a cutting direction and dispersed in rows without different concentrations. Therefore each abrasive particle shares work load so that a cycle of abrasion for the abrasive particles is delayed and useful life thereof is lengthened.

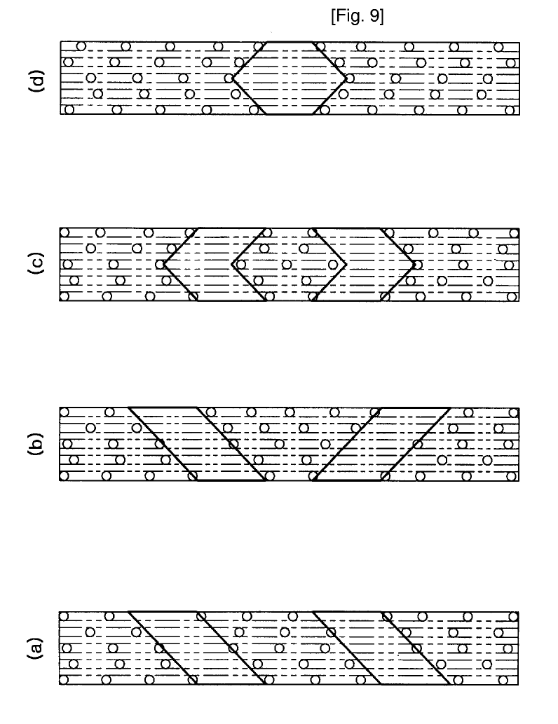

FIG. 9 shows examples of the cutting segment including a plurality of the low-concentration area according to the invention.

Referring to FIG. 9(a), each of the low-concentration areas has a parallelogrammic contour, and the parallelogrammic contours are arranged parallel to each other. Referring to FIG. 9(b), each of the low-concentration areas has a parallelogrammic contour, and the parallelogrammic contours are arranged nonparallel to each other.

Also, as shown in FIG. 9(C), each of the low-concentration areas has a V-shaped contour, and the V-shaped contours are oriented to face each other. As shown in FIG. (d), each of the low-concentration areas has an arrow-shaped contour with both ends facing opposite directions.

The invention provides a cutting tool with a cutting segment fabricated as described above.

A saw blade, a core bit and a grinding wheel may be used for the cutting tool.

The invention will be explained in greater detail with the examples which follow.

### EXAMPLE 1

A saw blade (inventive product 1) fabricated according to the invention and a saw blade (conventional product 1-3) fabricated according to conventional method were used to examine cutting rate and useful life in cutting a work piece, and the results are shown in table 2 below.

Inventive product 1 is a cutting segment utilizing diamond particles as abrasives and having a length L of 40, a thickness T of 3.2, a width W of 10.0, a diameter of 168 R (14 inches) and an average concentration of 0.75 Conc. For both outer rows and inner rows of diamond particles, the number of high-concentration areas n is 3. Each row had an average concentration of diamond particles dispersed thereon at a pre-determined rate. Therefore, the high-concentration areas each have a local concentration of 1.33 Conc.

Rows of diamond particles include 2 outer rows and 4 inner rows. Diamond particles used in the entire rows are MBS-955 available from G.E Corp. in U.S.A, and US 50/60 mesh with average particle diameter of 290□.

As a gap of the rows, Dout is 0.64 mm, and Din is 0.64 mm.

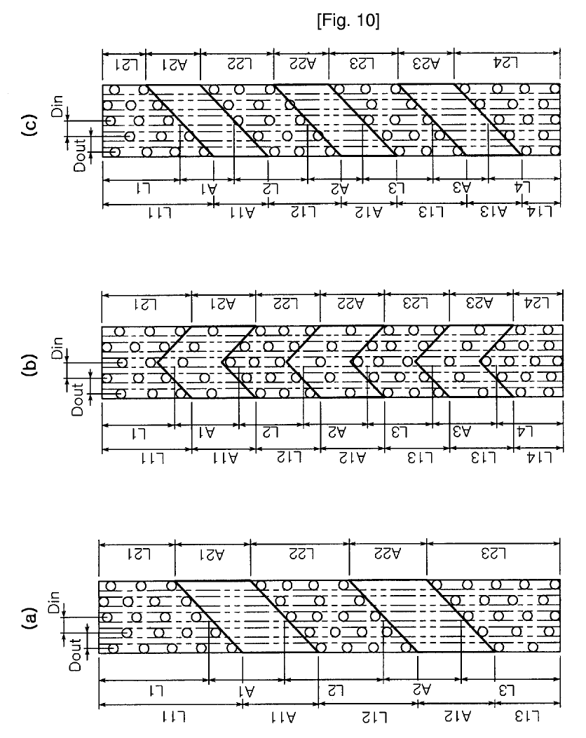

Inventive product 1 is shaped as in FIG. 10(a) with detailed dimensions set forth in Table 1. In Inventive product 1, the low-concentration area has a parallelogrammic contour and the contour has two sides slanted at an angle of 51.34 degree with respect to a vertical line of the cutting surface.

Conventional product 1 is a saw blade that uses a cutting segment, which is 40 L in length, 3.2 T in thickness, and 0.75 Conc. in average concentration and has diamond particles randomly dispersed. The diamond particles are MBS-955, US 50/60 mesh with average particle diameter of 290□.

Conventional product 2 is equal to conventional product 1 in terms of shape of cutting segment, diamond type and particle diameter, but has 0.9 Conc. of average concentration.

In conventional product 3, a cutting segment is quartered at equal intervals in a cutting direction and diamond particles are randomly dispersed in such a manner that concentration in the front and third parts in a cutting direction is 1.5 Conc.

Conventional product 3 is equal to conventional product 1 in terms of shape of a cutting segment, diamond type and particle diameter.

A 14 inch bridge sawing machine of 1800 rpm available from PEDRINI Corp. was used.

The products were cut with 30 mm of depth and 288 m of cutting length.

Inventive product 1, conventional product 1, conventional product 2, and conventional product 3 used mixed powder of cobalt, iron and copper of the same composition as metal powder (binder)

Table 2 shows a cutting index of power (kWh) required in cutting a work piece of 1□. The smaller index means a better cutting performance. In addition, the bigger index for useful life means longer useful life since the index for useful life indicates the amount of work done (□) for 1 mm abrasion of a cutting segment.

TABLE 1
Shape

| L11 | L21 | L1 | L12 | L22 | L2 | L13 | L23 | L3 | A11 | A21 | A1 | A12 | A22 | A2 |
|---|---|---|---|---|---|---|---|---|---|---|---|---|---|---|
| 10 | 6 | 8 | 8 | 8 | 8 | 6 | 10 | 8 | 8 | 8 | 8 | 8 | 8 | 8 |

TABLE 2

| | Inventive | Conventional | Conventional | Conventional |
|---|---|---|---|---|
| Sample No. 1 | product 1 | product 1 | product 2 | product 3 |
| Cutting | 1.182(100%) | (80.1%) | (75.2%) | (85.3%) |
| index[kWh/ [symbol] ] | | | | |
| Useful | 4.341(100%) | (77.3%) | (97.3%) | (81.2%) |
| life[ [symbol] /mm] | | | | |

As shown in table 2, inventive product 1 is superior to conventional products 1, 2, 3 in terms of cutting rate and useful life. Inventive product 1 has diamond particles arranged in rows and includes high concentration and low concentration areas according to the invention. Conventional products 1, 2 have diamond particles randomly arranged whereas conventional product 3 has high concentration and low concentration areas with diamond particles randomly arranged.

### EXAMPLE 2

A gap of the diamond rows arranged on a cutting segment, or a gap Dout between an outer row and an inner row and a gap Din between inner rows was adjusted as in Table 3 to fabricate the cutting segment and manufacture a saw blade therewith. Then cutting rate and useful life were examined. Table 5 shows results of cutting rate test and table 6 shows those of useful life.

The cutting segment is shaped as in FIG. 10(b). The low-concentration area has a contour symmetrical about the center of the cutting surface in a cutting direction. The low-concentration area has an arrow-shaped hexagonal contour with its dimensions set forth in Table 4.

Diamond particles used herein is US mesh 40/50 available from G.E Corp of U.S.A., with average diameter of 370□. The cutting segment is 40 L in length, 3.6 T in thickness, 8.5 W in width, and 168 R (14 inches). The number of and the gap between diamond rows are shown in Table 3.

For the cutting segments, the average concentration of diamond is 0.9 Conc. When the high-concentration area has 90% average concentration and the low-concentration area has 10% average concentration, the high-concentration has a local concentration of 1.62 Conc. and the low-concentration has a local concentration of 0.18 Conc. The number of the high-concentration areas n is 4. The low-concentration area has a contour with two sides angled at 51.34 degree with respect to a vertical line of the cutting segment.

The contour has both sides identically angled owing to its configuration symmetrical about the center of the cutting segment.

A 6.5 HP, 4200 RPM handcut available from STHIL Corp. was used as a cutting machine and work pieces of granite were used. The work pieces were cut with 20 mm of depth and 240 m of cutting length.

Meanwhile, cutting rate and useful life were measured for a saw blade (conventional product 4), which was manufactured under the same conditions as samples of Table 3 except for random arrangement of diamond particles. Cutting rate was 660.3□/min and useful life was 7.22□/mm.

For cutting rate and useful life in Tables 5 and 6 below, measured values were indicated by placing cutting rate and useful life of conventional product 4 at 100% respectively.

TABLE 3

| | Sample 1 | Sample 2 | Sample 3 | Sample 4 | Sample 5 | Sample 6 |
|---|---|---|---|---|---|---|
| Number | 5 | 5 | 5 | 6 | 7 | 8 |
| of Layers | | | | | | |
| Dout* | 0.592 mm | 0.354 mm | 0.40 mm | 0.563 mm | 0.50 mm | 0.374 mm |
| | (2.04 times) | (1.22 times | (1.37 times) | (1.94 times) | (1.72 times) | (1.29 times) |
| Din** | 0.576 mm | 0.734 mm | 0.705 mm | 0.446 mm | 0.383 mm | 0.374 mm |
| | (1.98 times) | (2.53 times) | (2.43 times) | (1.54 times) | (1.32 times) | (1.29 times) |

*Dout: Ratio to the average diamond diameter
**Din: Ratio to the average diamond diameter

TABLE 4
Shape

| L11 | L21 | L1 | L12 | L22 | L2 | L13 | L23 | L3 | L14 | L24 | L4 | A11 | A12 | A1 | A12 | A22 | A2 | A13 | A24 | A3 |
|---|---|---|---|---|---|---|---|---|---|---|---|---|---|---|---|---|---|---|---|---|
| 6 | 6 | 5 | 5 | 5 | 5 | 5 | 5 | 5 | 4 | 4 | 5 | 6.67 | 6.67 | 6.67 | 6.66 | 6.66 | 6.66 | 6.67 | 6.67 | 6.67 |

TABLE 5

| Sample No. | Sample 1 | Sample 2 | Sample 3 | Sample 4 | Sample 5 | Sample 6 |
|---|---|---|---|---|---|---|
| Cutting | (113.2%) | (115.1%) | (120.9%) | (128.4%) | (108.3%) | (101.1%) |
| rate[ [symbol] /min] | | | | | | |

TABLE 6

| Sample No. | Sample 1 | Sample 2 | Sample 3 | Sample 4 | Sample 5 | Sample 6 |
|---|---|---|---|---|---|---|
| Useful | (108.2%) | (107.1%) | (117.1%) | (125.2%) | (128.7%) | (129.2%) |
| life[ [symbol] /mm] | | | | | | |

As shown in Tables 5 and 6, samples 1 to 6 according to the invention are superior to conventional product 4. However, samples 3, 4, 5 are superior to samples 1, 2, 6 in terms of cutting rate and useful life. For samples 3, 4, 5, the ratio of a gap Dout between an outer row and an inner row to the average diamond diameter is less than 2.0 and the ratio of a gap Din between inner rows to the average diamond diameter is 1.3 to 2.5. For sample 1, the ratio of a gap Dout between an outer row and an inner row to the average diamond diameter is greater than 2.0. For sample 2, the ratio of a gap Din between inner rows to the average diamond diameter is greater than 2.5. For sample 6, the ratio of a gap Din between inner rows to the average diamond diameter is less than 1.3.

### EXAMPLE 3

A cutting segment was fabricated by varying the mean length L of the high-concentration area, and the mean length A of the low-concentration area. Diamond particles were locally dispersed only on the high-concentration area without being dispersed on the low-concentration area. The cutting segment was used to fabricate a saw blade, and cutting rate and useful life thereof were measured. The results are shown in Tables 9 and 10.

Samples 7, 9, 10 shown in Tables 9 and 10 are shaped as in FIG. 10(a). Also, sample 8 is shaped as in FIG. 10(b) and sample 11 is shaped as in FIG. 10(c). Tables 7 and 8 show detailed dimensions, the number of the high-concentration areas, local concentration, a ratio L/A of the mean length L of the high-concentration area to the mean length of the low-concentration area.

The low-concentration area has a parallelogrammic contour and the contour has two sides slanted at an angle of 32 degree with respect to a vertical line of the cutting segment.

A machine used was an engine-driven table-type cutting machine available from EDCO Corp. having 4.5 horse power and 3500 RPM, and granite and concrete were used for a work piece.

Work pieces of granite were cut with 20 mm of depth and 240 m of cutting length, while work pieces of concrete were cut with 30 mm of depth and 240 m of cutting length.

Cutting rate and useful life were examined through the aforesaid cutting tests. The results of cutting rate and useful life are shown in Tables 9 and 10, respectively.

TABLE 7

| | | L11 L21 L1 | L12 L22 L2 | L13 L23 L3 |
|---|---|---|---|---|
| | n | A11 A21 A1 | L12 A22 A2 | L13 A23 A3 |
| Sample 7 | 3 | 3 5 4 | 4 4 4 | 5 3 4 |
| | | 14 14 14 | 14 14 14 | |
| Sample 8 | 4 | 2 4 3 | 3 3 3 | 3 3 3 |
| | | 9.33 9.33 9.33 | 9.33 9.33 9.33 | 9.33 9.33 9.33 |
| Sample 9 | 3 | 8.33 10.33 9.33 | 9.33 9.33 9.33 | 10.33 8.33 9.33 |
| | | 6 6 6 | 6 6 6 | |
| Sample 10 | 3 | 9 11 10 | 10 10 10 | 11 9 10 |
| | | 5 5 5 | 5 5 5 | 5 5 5 |
| Sample 11 | 4 | 6.5 8.5 7.5 | 7.5 7.5 7.5 | 7.5 7.5 7.5 |
| | | 3.33 3.33 3.33 | 3.33 3.33 3.33 | 3.33 3.33 3.33 |

TABLE 8

| | L14 L24 L4 | Local concentration | L/A |
|---|---|---|---|
| Sample 7 | | 3.0 Conc. | 0.29 |
| Sample 8 | 4 2 3 | 3.0 Conc. | 0.32 |
| Sample 9 | | 1.29 Conc. | 1.56 |
| Sample 10 | | 1.2 Conc. | 2 |
| Sample 11 | 8.5 6.5 7.5 | 1.2 Conc. | 2.25 |

TABLE 9

| | Sample 7 | Sample 8 | Sample 9 | Sample 10 | Sample 11 |
|---|---|---|---|---|---|
| Granite | 673.5 | 705.9 | 740.5 | 714.6 | 663.1 |
| [ [symbol] /min] | | | | | |
| Concrete | 849.2 | 908.2 | 982.3 | 923.1 | 836.7 |
| [ [symbol] /min] | | | | | |

TABLE 10

| | Sample 7 | Sample 8 | Sample 9 | Sample 10 | Sample 11 |
|---|---|---|---|---|---|
| Granite | 16.11 | 16.52 | 17.62 | 17.02 | 16.76 |
| [ [symbol] /mm] | | | | | |
| Concrete | 18.25 | 19.08 | 21.31 | 20.93 | 19.27 |
| [ [symbol] /mm] | | | | | |

As shown in Tables 9 and 10, cutting rate and useful life are superior when the ratio L/A of the mean length L of the high-concentration area to the mean length A of the low-concentration area is 0.3 to 2.0.

### INDUSTRIAL APPLICABILITY

As set forth above, according to the present invention, cutting efficiency of the abrasive particles can be elevated by properly arranging the abrasive particles. As a result, for the cutting segments requiring high concentration, superior cutting rate and longer useful life can be ensured at a cheap price. Also, for the cutting segments requiring low concentration, superior cutting rate and longer useful life are attainable as equally as the cutting segments requiring high concentration.

While the present invention has been shown and described in connection with the preferred embodiments, it will be apparent to those skilled in the art that modifications and variations can be made without departing from the spirit and scope of the invention as defined by the appended claims.

1. A cutting segment of a cutting tool for cutting a work piece on a cutting surface, the cutting segment comprising a number of abrasive particles arranged in a plurality of rows extended along a cutting direction, the abrasive rows being placed side by side with one another across the cutting direction and stacked vertically from the cutting surface,
wherein each of the abrasive rows includes high-concentration parts and low-concentration parts along the cutting direction on the cutting surface, the high-concentration parts showing a concentration higher than an average concentration of the each abrasive row, and the low-concentration parts showing a concentration lower than the average concentration, and
wherein the high-concentration parts are grouped together to form a high-concentration area on the cutting surface and low-concentration parts are grouped together to form a low-concentration area on the cutting surface, and the high-concentration areas and the low-concentration areas are extended to both sides of the segment, respectively,
wherein the low-concentration area has a polygonal contour on the cutting surface, and
wherein the high-concentration area alternates with the low-concentration area along the cutting direction.

2. The cutting segment of the cutting tool according to claim 1, wherein the polygonal contour has at least one side slanted in a direction perpendicular to the cutting direction.

3. The cutting segment of the cutting tool according to claim 1, comprising a plurality of the low-concentration area each having a parallelogrammic contour, wherein the parallelogrammic contours are arranged parallel to each other.

4. The cutting segment of the cutting tool according to claim 1, comprising a plurality of the low-concentration area each having a parallelegrammic contour, wherein the parallelogrammic contours are arranged nonparallel to each other.

5. The cutting segment of the cutting tool according to claim 1, comprising a plurality of the low-concentration area each having a V-shaped contour, wherein the V-shaped contours are oriented to face each other.

6. The cutting segment of the cutting tool according to claim 1, comprising a plurality of the low-concentration area each having an arrow-shaped contour with both ends facing opposite directions.

7. The cutting segment of the cutting tool according to claim 1, wherein the low-concentration area has an arrow-shaped contour.

8. The cutting segment of the cutting tool according to claim 1, wherein the abrasive rows are stacked in such a manner that abrasive particles are successively protruded from the cutting surface with a predetermined pattern in cutting a work piece.

9. The cutting segment of the cutting tool according to claim 1, wherein a gap between one of outer rows placed in both sides of the segment and an adjacent inner row is 2.0 times of or less than the average diameter of the abrasive particles, and a gap between inner rows placed between the outer rows is 4.0 times of or less than the average diameter of the abrasive particles.

10. The cutting segment of the cutting tool according to claim 8, wherein a gap between one of outer rows placed in both sides of the segment and an adjacent inner row is 2.0 times of or less than the average diameter of the abrasive particles, and a gap between inner rows placed between the outer rows is 4.0 times of or less than the average diameter of the abrasive particles.

11. The cutting segment of the cutting tool according to claim 1, wherein the low-concentration area has no abrasive particles.

12. The cutting segment of the cutting tool according to claim 8, wherein the low-concentration areas has no abrasive particles.

13. The cutting segment of the cutting tool according to claim 1, wherein the ratio of the mean length of the high-concentration area to the mean length of the low-concentration area is 0.3 to 2.0.

14. The cutting segment of the cutting tool according to claim 8, wherein the ratio of the mean length of the high-concentration area to the mean length of the low-concentration area is 0.3 to 2.0.

15. The cutting segment of the cutting tool according to claim 1, wherein the abrasive rows are stacked in such a manner that the low-concentration part alternates with the high-concentration part in a direction perpendicular to the cutting surface.

16. A cutting segment of a cutting tool for cutting a work piece on a cutting surface, the cutting segment comprising a number of abrasive particles arranged in a plurality of rows extended along a cutting direction, the abrasive rows being placed side by side with one another across the cutting direction and stacked vertically from the cutting surface,
wherein the abrasive rows include outer abrasive rows placed in both sides of the segment and a plurality of inner abrasive rows placed between the outer rows,
wherein at least one of the outer rows has abrasive particles arranged with uniform concentration,
wherein each of the inner rows includes high-concentration parts and low-concentration parts along the cutting direction on the cutting surface, the high-concentration parts showing a concentration higher than an average concentration of the each abrasive row, and the low-concentration parts showing a concentration lower than the average concentration,
wherein the high-concentration parts are grouped together to form a high-concentration area on the cutting surface and low-concentration parts are grouped together to form a low-concentration area on the cutting surface,
wherein the low-concentration area has a polygonal contour on a cutting surface, and
wherein the high-concentration area alternates with the low-concentration area along the cutting direction.

17. The cutting segment of the cutting tool according to claim 16, wherein the polygonal contour has at least one side slanted in a direction perpendicular to the cutting direction.

18. The cutting segment of the cutting tool according to claim 16, comprising a plurality of the low-concentration area each having a parallelogrammic contour, wherein the parallelogrammic contours are arranged parallel to each other.

19. The cutting segment of the cutting tool according to claim 16, wherein the low-concentration areas have a parallelogrammic contour, comprising a plurality of the low-concentration area having a parallelegrammic contour, wherein the parallelogrammic contours are arranged nonparallel to each other.

20. The cutting segment of the cutting tool according to claim 16, comprising a plurality of the low-concentration area each having a V-shaped contour, wherein the V-shaped contours are oriented to face each other.

21. The cutting segment of the cutting tool according to claim 16, comprising a plurality of the low-concentration area each having an arrow-shaped contour with both ends facing opposite directions.

22. The cutting segment of the cutting tool according to claim 16, wherein the low-concentration area has an arrow-shaped contour.

23. The cutting segment of the cutting tool according to claim 16, wherein the abrasive rows are stacked in such a manner that abrasive particles are successively protruded from the cutting surface with a predetermined pattern in cutting a work piece.

24. The cutting segment of the cutting tool according to claim 16, wherein a gap between one of outer rows placed in both sides of the segment and an adjacent inner abrasive row is 2.0 times of or less than the average diameter of the abrasive particles, and a gap between inner rows placed between the outer rows is 4.0 times of or less than the average diameter of the abrasive particles.

25. The cutting segment of the cutting tool according to claim 23, wherein a gap between one of outer rows placed in both sides of the segment and an adjacent inner row is 2.0 times of or less than the average diameter of the abrasive particles, and a gap between inner rows placed between the outer rows is 4.0 times of or less than the average diameter of the abrasive particles.

26. The cutting segment of the cutting tool according to claim 16, wherein the low-concentration area has no abrasive particles.

27. The cutting segment of the cutting tool according to claim 16, wherein the low-concentration area has no abrasive particles.

28. The cutting segment of the cutting tool according to claim 16, wherein the ratio of the mean length of the high-concentration area to the mean length of the low-concentration area is 0.3 to 2.0.

29. The cutting segment of the cutting tool according to claim 23, wherein the ratio of the mean length of the high-concentration area to the mean length of the low-concentration area is 0.3 to 2.0.

30. The cutting segment of the cutting tool according to claim 16, wherein the abrasive rows are stacked in such a manner that low-concentration parts alternate with high-concentration parts in a direction perpendicular to the cutting surface.

31. A cutting tool having a cutting segment as described in claim 1.

32. A cutting tool having a cutting segment as described in claim 16.
